(19) United States
(12) Patent Application Publication
(10) Pub. No.: US 2023/0038570 A1
(43) Pub. Date: Feb. 9, 2023

(54) TECHNOLOGIES FOR SECURE PHYSICAL ADDRESS ALIAS MAINTENANCE AND USAGE

(71) Applicant: SYNCSOFT, LLC, Oklahoma City, OK (US)

(72) Inventors: Edward A. FLICK, Normal, OK (US); Chad N. WILLIAMSON, Oklahoma City, OK (US)

(21) Appl. No.: 17/791,485

(22) PCT Filed: Feb. 4, 2021
(86) PCT No.: PCT/US2021/016512

§ 371 Date: Jul. 7, 2022

Related U.S. Application Data
(60) Provisional application No. 62/969,949, filed on Feb. 4, 2020.

(51) Int. Cl. G06Q 10/08; G06F 21/44

(52) U.S. Cl. CPC G06Q 10/083; G06F 21/44; G06Q 50/32

(57) ABSTRACT

Technologies for physical address aliasing include an alias server, an owner device, and a consumer device in communication over a network. The owner device submits an alias identifier and a physical address to the alias server. The alias server associates the alias identifier and the physical address in a secure address database. The alias identifier may be a human-readable unique identifier. The consumer device submits a request including the alias identifier to the alias server. The alias server authenticates the consumer device, retrieves the physical address associated with the alias identifier, and sends a response based on the physical address to the consumer device. The response may be generated based on an access role associated with the consumer device. The response may include the physical address, a lower-resolution address based on the physical address, or confirmation of validity of the alias identifier. Other embodiments are described and claimed.

### CROSS-REFERENCE TO RELATED APPLICATION

The present application claims the benefit of U.S. Provisional Patent Application No. 62/969,949, which was filed on Feb. 4, 2020, the entire disclosure of which is hereby incorporated by reference.

### BACKGROUND

Physical addresses such as street addresses or other mailing addresses are used for many purposes, including shipping, billing, employment records, tax records, and other purposes. Typical systems store a complete street address for individuals or businesses. An individual or business may use a post office box (“P.O. box”) instead of a physical street address. Typically, a P.O. box user must physically travel to a post office facility to retrieve mail and packages sent to a P.O. box.

### SUMMARY

According to one aspect of the disclosure, a computing device for physical address aliasing includes an application programing interface and a data access layer. The application programing interface is to receive a request from an address consumer device, wherein the request includes an alias identifier. The data access layer is to authenticate the address consumer device, and retrieve a physical address associated with the alias identifier from an address database in response to authentication of the address consumer device. The application programming interface is further to send a response based on the physical address to the address consumer device in response to receipt of the request and retrieval of the physical address. In an embodiment, the alias identifier includes a human-readable unique identifier.

In an embodiment, the data access layer is further to identify an access role associated with the address consumer device in response to the authentication of the address consumer device, and generate the response based on the physical address and the access role. In an embodiment, the access role includes a shipper role and the response includes the physical address. In an embodiment, the access role includes a partner role and the response includes a low-resolution address based on the physical address. In an embodiment, the low-resolution address includes a postal code. In an embodiment, the access role includes a confirmation role and the response includes an indication of whether the address alias is valid.

In an embodiment, the computing device further includes an owner access layer to authenticate an address owner device, and receive the physical address and the alias identifier from the address owner device, wherein the data access layer is further to associate the physical address and the alias identifier in the address database in response to authentication of the address owner device. In an embodiment, to associate the physical address and the alias identifier includes to update the physical address associated with the alias identifier. In an embodiment, the owner access layer is further to scrub the physical address to generate a corrected address, and to associate the physical address and the alias identifier includes to associate the corrected physical address and the alias identifier.

According to another aspect, a computing device for physical address aliasing includes an application programming interface client to send a request to an address alias server, wherein the request includes an alias identifier, authenticate to the address alias server, and receive a response from the address alias server in response to sending of the request and authentication to the address alias server, wherein the response is indicative of a physical address associated with the alias identifier. In an embodiment, alias identifier includes a human-readable unique identifier. In an embodiment, the computing device further includes an alias interface to receive the alias identifier from an address owner device, wherein to send the request includes to send the request in response to receipt of the alias identifier.

In an embodiment, the computing device further includes an address consumer to consume the response indicative of the physical address. In an embodiment, the request identifies a requested access role. In an embodiment, to authenticate to the address alias server includes to authenticate a requested access role. In an embodiment, the requested access role includes a shipper role, a partner role, or a confirmation role. In an embodiment, to receive the response indicative of the physical address includes to receive the physical address. In an embodiment, to receive the response indicative of the physical address includes to receive a low-resolution address based on the physical address. In an embodiment, the low-resolution address includes a postal code. In an embodiment, to receive the response indicative of the physical address includes to receive an indication of whether the address alias is valid.

According to another aspect, a computing device for physical address aliasing includes an alias manager and an alias consumer interface. The alias manager is to authenticate to an address alias server and submit an alias identifier and a physical address to the address alias server in response to authentication to the address alias server. The alias consumer interface is to send the alias identifier to an address consumer device. In an embodiment, the alias identifier includes a human-readable unique identifier. In an embodiment, to submit the alias identifier and the physical address includes to submit an updated physical address.

According to another aspect, a method for physical address aliasing includes receiving, by a computing device, a request from an address consumer device, wherein the request includes an alias identifier; authenticating, by the computing device, the address consumer device; retrieving, by the computing device, a physical address associated with the alias identifier from an address database in response to authenticating the address consumer device; and sending, by the computing device, a response based on the physical address to the address consumer device in response to receiving the request and retrieving the physical address. In an embodiment, the alias identifier includes a human-readable unique identifier.

In an embodiment, the method further includes identifying, by the computing device, an access role associated with the address consumer device in response to authenticating the address consumer device; and generating, by the computing device, the response based on the physical address and the access role. In an embodiment, the access role includes a shipper role and the response includes the physical address. In an embodiment, the access role includes a partner role and the response includes a low-resolution address based on the physical address. In an embodiment, the low-resolution address includes a postal code. In an embodiment, the access role includes a confirmation role and the response includes an indication of whether the address alias is valid.

In an embodiment, the method further includes authenticating, by the computing device, an address owner device; receiving, by the computing device, the physical address and the alias identifier from the address owner device; and associating, by the computing device, the physical address and the alias identifier in the address database in response to authenticating the address owner device. In an embodiment, associating the physical address and the alias identifier includes updating the physical address associated with the alias identifier. In an embodiment, the method further includes scrubbing, by the computing device, the physical address to generate a corrected address; wherein associating the physical address and the alias identifier includes associating the corrected physical address and the alias identifier.

According to another aspect, a method for physical address aliasing includes sending, by a computing device, a request to an address alias server, wherein the request includes an alias identifier; authenticating, by the computing device, to the address alias server; and receiving, by the computing device, a response from the address alias server in response to sending the request and authenticating to the address alias server, wherein the response is indicative of a physical address associated with the alias identifier. In an embodiment, the alias identifier includes a human-readable unique identifier. In an embodiment, the method further includes receiving, by the computing device, the alias identifier from an address owner device; wherein sending the request includes sending the request in response to receiving the alias identifier.

In an embodiment, the method further includes consuming, by the computing device, the response indicative of the physical address. In an embodiment, the request identifies a requested access role. In an embodiment, the requested access role includes a shipper role, a partner role, or a confirmation role. In an embodiment, authenticating to the address alias server includes authenticating a requested access role. In an embodiment, receiving the response indicative of the physical address includes receiving the physical address. In an embodiment, receiving the response indicative of the physical address includes receiving a low-resolution address based on the physical address. In an embodiment, the low-resolution address includes a postal code. In an embodiment, receiving the response indicative of the physical address includes receiving an indication of whether the address alias is valid.

According to another aspect, a method for physical address aliasing includes authenticating, by a computing device, to an address alias server; submitting, by the computing device, an alias identifier and a physical address to the address alias server in response to authenticating to the address alias server; and sending, by the computing device, the alias identifier to an address consumer device. In an embodiment, the alias identifier includes a human-readable unique identifier. In an embodiment, submitting the alias identifier and the physical address includes submitting an updated physical address.

According to another aspect, one or more computer-readable storage media include a plurality of instructions that in response to being executed cause a computing device to receive a request from an address consumer device, wherein the request includes an alias identifier; authenticate the address consumer device; retrieve a physical address associated with the alias identifier from an address database in response to authenticating the address consumer device; and send a response based on the physical address to the address consumer device in response to receiving the request and retrieving the physical address. In an embodiment, the alias identifier includes a human-readable unique identifier.

In an embodiment, the one or more computer-readable storage media further include a plurality of instructions that in response to being executed cause the computing device to identify an access role associated with the address consumer device in response to authenticating the address consumer device; and generate the response based on the physical address and the access role. In an embodiment, the access role includes a shipper role and the response includes the physical address. In an embodiment, the access role includes a partner role and the response includes a low-resolution address based on the physical address. In an embodiment, the low-resolution address includes a postal code. In an embodiment, the access role includes a confirmation role and the response includes an indication of whether the address alias is valid.

In an embodiment, the one or more computer-readable storage media further include a plurality of instructions that in response to being executed cause the computing device to authenticate an address owner device; receive the physical address and the alias identifier from the address owner device; and associate the physical address and the alias identifier in the address database in response to authenticating the address owner device. In an embodiment, to associate the physical address and the alias identifier includes to update the physical address associated with the alias identifier. In an embodiment, the one or more computer-readable storage media further include a plurality of instructions that in response to being executed cause the computing device to scrub the physical address to generate a corrected address; wherein to associate the physical address and the alias identifier includes to associate the corrected physical address and the alias identifier.

According to another aspect, one or more computer-readable storage media include a plurality of instructions that in response to being executed cause a computing device to send a request to an address alias server, wherein the request includes an alias identifier; authenticate to the address alias server; and receive a response from the address alias server in response to sending the request and authenticating to the address alias server, wherein the response is indicative of a physical address associated with the alias identifier. In an embodiment, the alias identifier includes a human-readable unique identifier. In an embodiment, the one or more computer-readable storage media further include a plurality of instructions that in response to being executed cause the computing device to receive the alias identifier from an address owner device; wherein to send the request includes to send the request in response to receiving the alias identifier.

In an embodiment, the one or more computer-readable storage media further include a plurality of instructions that in response to being executed cause the computing device to consume the response indicative of the physical address. In an embodiment, the request identifies a requested access role. In an embodiment, the requested access role includes a shipper role, a partner role, or a confirmation role. In an embodiment, to authenticate to the address alias server includes to authenticate a requested access role. In an embodiment, to receive the response indicative of the physical address includes to receive the physical address. In an embodiment, to receive the response indicative of the physical address includes to receive a low-resolution address based on the physical address. In an embodiment, the low-resolution address includes a postal code. In an embodiment, to receive the response indicative of the physical address includes to receive an indication of whether the address alias is valid.

According to another aspect, one or more computer-readable storage media include a plurality of instructions that in response to being executed cause a computing device to authenticate to an address alias server; submit an alias identifier and a physical address to the address alias server in response to authenticating to the address alias server; and send the alias identifier to an address consumer device. In an embodiment, the alias identifier includes a human-readable unique identifier. In an embodiment, to submit the alias identifier and the physical address includes to submit an updated physical address.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for physical address aliasing;

FIG. 2 is a simplified block diagram of at least one embodiment of various environments of the system of FIG. 1;

FIG. 3 is a simplified flow diagram of at least one embodiment of a method for physical address aliasing that may be executed by an address alias server of FIGS. 1-2;

FIG. 4 is a simplified flow diagram of at least one embodiment of a method for physical address aliasing that may be executed by an address owner device of FIGS. 1-2; and

FIG. 5 is a simplified flow diagram of at least one embodiment of a method for physical address aliasing that may be executed by an address consumer device of FIGS. 1-2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. Furthermore, the disclosed embodiments may be initially encoded as a set of preliminary instructions (e.g., encoded on a machine-readable storage medium) that may require preliminary processing operations to prepare the instructions for execution on a destination device. The preliminary processing may include combining the instructions with data present on a device, translating the instructions to a different format, performing compression, decompression, encryption, and/or decryption, combining multiple files that include different sections of the instructions, integrating the instructions with other code present on a device, such as a library, an operating system, etc., or similar operations. The preliminary processing may be performed by the source compute device (e.g., the device that is to send the instructions), the destination compute device (e.g., the device that is to execute the instructions), or an intermediary device. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

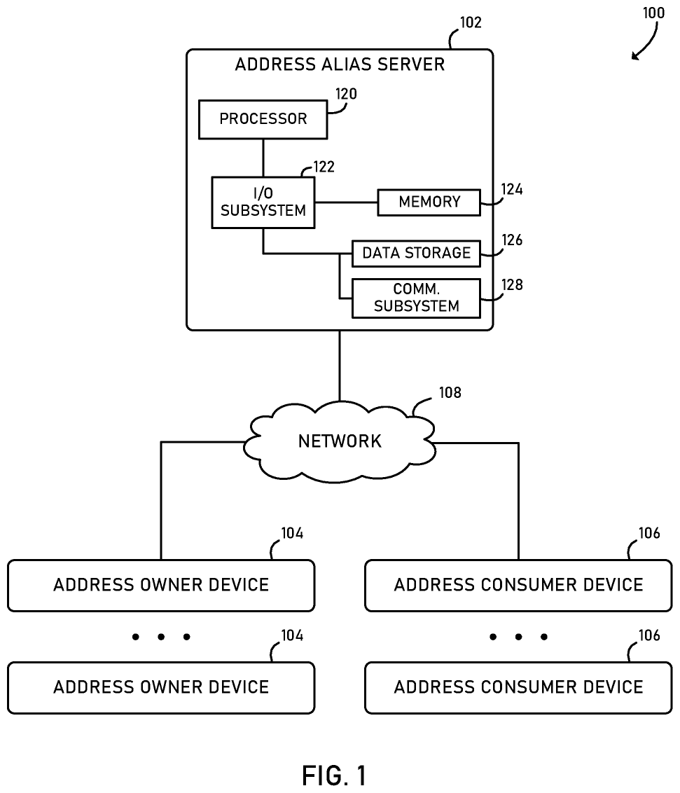

Referring now to FIG. 1, a system 100 for physical address aliasing includes an address alias server 102 in communication with multiple address owner devices 104 and address consumer devices 106 over a network 108. In use, as described further below, an address owner such as an end user, business owner, or other entity uses the owner device 104 to access the alias server 102 and configure an alias identifier with a physical address. The owner device 104 may use the alias identifier instead of a physical address, for example providing the alias identifier to an online store or other vendor. The alias identifier is provided to a consumer device 106, which is controlled by a shipping service, post office, or other entity that is authorized to access the physical address. The consumer device 106 authenticates to the alias server 102 and requests a physical address for the alias. When successfully authenticated, the alias server 102 provides secure access to the physical address according to an access role associated with the consumer device 106. The consumer device 106 may use the physical address (or other data based on the physical address) as requested by the owner device 104. For example, the consumer device 106 may ship an item to the physical address, use the physical address for shipping estimates or payment verification, or perform other usages. Thus, the system 100 may allow an address owner to provide a mailing address to an authorized consumer without disclosing a physical address or requiring the consumer to store the physical address, which may improve safety and privacy over existing systems. Additionally, the address owner may update physical address records with the alias server 102, allowing mail and packaging to be easily routed to the updated address without updating numerous address consumers. Further, the alias identifier may be easier for users to remember and save without error as compared to traditional physical addresses, and thus may provide businesses with an improved technique for unique branding.

The alias server 102 may be embodied as any type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. As shown in FIG. 1, the alias server 102 illustratively include a processor 120, an input/output subsystem 122, a memory 124, a data storage device 126, and a communication subsystem 128, and/or other components and devices commonly found in a server or similar computing device. Of course, the alias server 102 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments. Additionally, in some embodiments, the alias server 102 may be embodied as a “virtual server” formed from multiple computing devices distributed across the network 108 and operating in a public or private cloud. Accordingly, although the alias server 102 is illustrated in FIG. 1 as embodied as a single server computing device, it should be appreciated that the alias server 102 may be embodied as multiple devices cooperating together to facilitate the functionality described below.

The processor 120 may be embodied as any type of processor capable of performing the functions described herein. Similarly, the memory 124 may be embodied as any type of volatile or non-volatile memory or data storage capable of performing the functions described herein. In operation, the memory 124 may store various data and software used during operation of the alias server 102 such as operating systems, applications, programs, libraries, and drivers. As shown, the processor 120 is communicatively coupled to the I/O subsystem 122, which may be embodied as circuitry and/or components to facilitate input/output operations with the processor 120, the memory 124, and other components of the alias server 102. For example, the I/O subsystem 122 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations. In some embodiments, the memory 124 may be directly coupled to the processor 120, for example via an integrated memory controller hub. Additionally, in some embodiments, the I/O subsystem 122 may form a portion of a system-on-a-chip (SoC) and be incorporated, along with the processor 120, the memory 124, and/or other components of the alias server 102, on a single integrated circuit chip.

The data storage device 126 may be embodied as any type of device or devices configured for short-term or long-term storage of data such as, for example, memory devices and circuits, memory cards, hard disk drives, solid-state drives, non-volatile flash memory, or other data storage devices. The alias server 102 also includes the communication subsystem 128, which may be embodied as any communication circuit, device, or collection thereof, capable of enabling communications between the alias server 102 and other remote devices over the computer network 108. For example, the communication subsystem 128 may be embodied as or otherwise include a network interface controller (NIC) for sending and/or receiving network data with remote devices. The communication subsystem 128 may be configured to use any one or more communication technology (e.g., wired or wireless communications) and associated protocols (e.g., Ethernet, InfiniBand®, Bluetooth®, Wi-Fi®, WiMAX, 3G, 4G LTE, etc.) to effect such communication. The alias server 102 may also include any number of additional input/output devices, interface devices, hardware accelerators, and/or other peripheral devices.

Each owner device 104 may be embodied as any type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Similarly, each consumer device 106 may be embodied as any type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Thus, each owner device 104 and consumer device 106 includes components and devices commonly found in a computer or similar computing device, such as a processor, an I/O subsystem, a memory, a data storage device, and/or communication circuitry. Those individual components of the owner device 104 and the consumer device 106 may be similar to the corresponding components of the alias server 102, the description of which is applicable to the corresponding components of the owner device 104 and/or the consumer device 106 and is not repeated herein so as not to obscure the present disclosure.

The alias server 102, the owner device 104, and the consumer device 106 are configured to transmit and receive data with each other and/or other devices of the system 100 over the network 108. The network 108 may be embodied as any number of various wired and/or wireless networks, or hybrids or combinations thereof. For example, the network 108 may be embodied as, or otherwise include, a wired or wireless local area network (LAN), and/or a wired or wireless wide area network (WAN). As such, the network 108 may include any number of additional devices, such as additional computers, routers, and switches, to facilitate communications among the devices of the system 100.

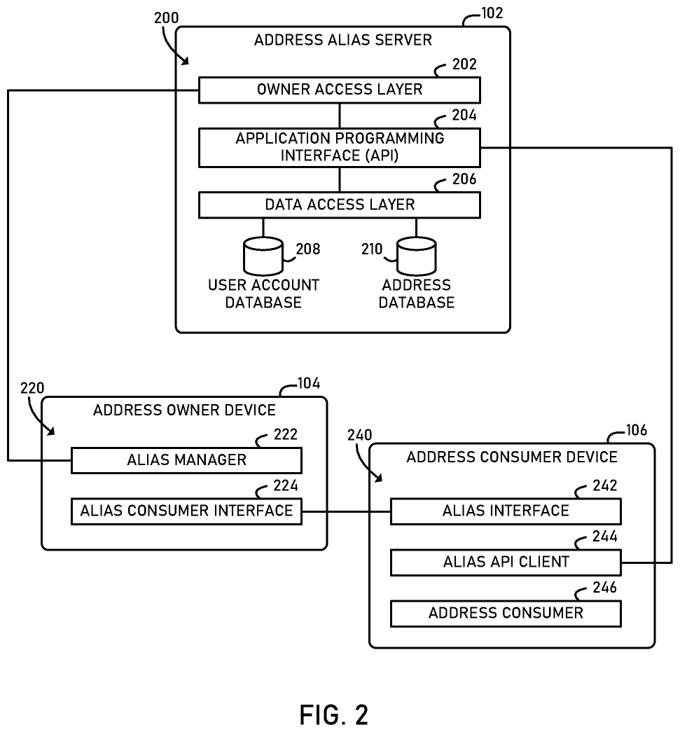

Referring now to FIG. 2, in an illustrative embodiment, the alias server 102 establishes an environment 200 during operation. The illustrative environment 200 includes an owner access layer 202, an alias application programming interface (API) 204, and a data access layer 206. As shown, the various components of the environment 200 may be embodied as hardware, firmware, software, or a combination thereof. As such, in some embodiments, one or more of the components of the environment 200 may be embodied as circuitry or collection of electrical devices (e.g., owner access layer circuitry 202, alias API circuitry 204, and/or data access layer circuitry 206). It should be appreciated that, in such embodiments, one or more of the owner access layer circuitry 202, the alias API circuitry 204, and/or the data access layer circuitry 206 may form a portion of the processor 120, the I/O subsystem 122, and/or other components of the alias server 102. Additionally, in some embodiments, one or more of the illustrative components may form a portion of another component and/or one or more of the illustrative components may be independent of one another.

The owner access layer 202 is configured to authenticate an address owner device 104 and receive a physical address and an alias identifier from the address owner device 104. The address owner device 104 may be authenticated using a user account database 208. The alias identifier may be embodied as a human-readable unique identifier. The owner access layer 202 may be further configured to scrub the physical address to generate a corrected address.

The alias API 204 is configured to receive a request from an address consumer device 106 that includes an alias identifier. The alias API 204 is further configured to send a response to the address consumer device 106 based on the physical address associated with the alias identifier as described further below.

The data access layer 206 is configured to associate the physical address (and/or the corrected address) and the alias identifier received from the owner device 104 in an address database 210 in response to authenticating the address owner device 104. The data access layer 206 is further configured to authenticate the address consumer device 106 and retrieve a physical address associated with the alias identifier received from the address consumer device 106 from the address database 210 in response to authenticating the address consumer device 106. The data access layer 206 may be further configured to identify an access role associated with the address consumer device 106 in response to authenticating the address consumer device 106 and generate the response based on the physical address and the access role. The access role may be embodied as a shipper role, a partner role, or a confirmation role, and the response may include the physical address, a low-resolution address based on the physical address, or an indication of whether the address alias is valid, respectively.

Still referring to FIG. 2, in an illustrative embodiment, an owner device 104 establishes an environment 220 during operation. The illustrative environment 220 includes an alias manager 222 and an alias consumer interface 224. As shown, the various components of the environment 220 may be embodied as hardware, firmware, software, or a combination thereof. As such, in some embodiments, one or more of the components of the environment 220 may be embodied as circuitry or collection of electrical devices (e.g., alias manager circuitry 222 and/or alias consumer interface circuitry 224). It should be appreciated that, in such embodiments, one or more of the alias manager circuitry 222 and/or the alias consumer interface circuitry 224 may form a portion of the processor, the I/O subsystem, and/or other components of the owner device 104. Additionally, in some embodiments, one or more of the illustrative components may form a portion of another component and/or one or more of the illustrative components may be independent of one another.

The alias manager 222 is configured to authenticate to the address alias server 102 and to submit an alias identifier and a physical address to the address alias server 102 in response to authentication. Submitting the physical address may include submitting an updated physical address. The alias consumer interface 224 is configured to send the alias identifier to an address consumer device 106.

Still referring to FIG. 2, in an illustrative embodiment, a consumer device 106 establishes an environment 240 during operation. The illustrative environment 240 includes alias interface 242, an alias API client 244, and an address consumer 246. As shown, the various components of the environment 240 may be embodied as hardware, firmware, software, or a combination thereof. As such, in some embodiments, one or more of the components of the environment 240 may be embodied as circuitry or collection of electrical devices (e.g., alias interface circuitry 242, alias API client circuitry 244, and/or address consumer circuitry 246). It should be appreciated that, in such embodiments, one or more of the alias interface circuitry 242, the alias API client circuitry 244, and/or the address consumer circuitry 246 may form a portion of the processor, the I/O subsystem, and/or other components of the consumer device 106. Additionally, in some embodiments, one or more of the illustrative components may form a portion of another component and/or one or more of the illustrative components may be independent of one another.

The alias interface 242 is configured to receive an alias identifier from an address owner device 104. As described above, the alias identifier may be embodied as a human-readable unique identifier.

The alias API client 244 is configured to send a request to the address alias server 102 that includes the alias identifier. The request may be sent in response to receiving the alias identifier from the address owner device 104. The request may identify a requested access role, such as a shipper role, a partner role, or a confirmation role. The alias API client 244 is further configured to authenticate to the address alias server 102 and to receive a response from the address alias server 102. Authenticating to the address alias server 102 ma include authenticating a requested access role. The response is indicative of a physical address associated with the alias identifier. In some embodiments, the response may include the physical address, a low-resolution address based on the physical address (e.g., a postal code), or an indication of whether the address alias is valid. The address consumer 246 is configured to consume the response indicative of the physical address.

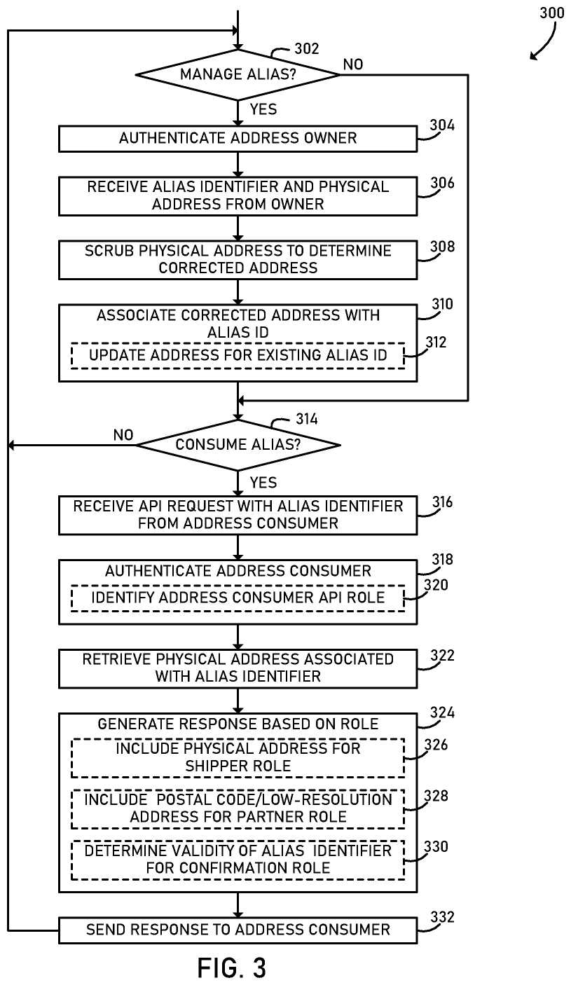

Referring now to FIG. 3, in use, the alias server 102 may execute a method 300 for physical address aliasing. It should be appreciated that, in some embodiments, the operations of the method 300 may be performed by one or more components of the environment 200 of the alias server 102 as shown in FIG. 2. The method 300 begins with block 302, in which the alias server 102 determines whether to manage an alias identifier. The alias server 102 may, for example, monitor for management requests made to a web portal from one or more owner devices 104. If the alias server 102 determines not to manage an alias identifier, the method 300 branches ahead to block 312, described below. If the alias server 102 determines to manage an alias identifier, the method 300 advances to block 304.

In block 304, the alias server 102 authenticates the address owner device 104. The alias server 102 may authenticate the address owner device 104 using information stored in the user account database 208 or any other appropriate technique. The alias server 102 may, for example, verify user account credentials provided by the address owner device 104 against the user account database 208. If the owner device 104 is not successfully authenticated, the alias server 102 may indicate an error or otherwise stop execution of the method 300. If the owner device 104 is successfully authenticated, the method 300 advances to block 306.

In block 306, the alias server 102 receives an alias identifier and an associated physical address from the address owner device 104. The alias identifier may be embodied as human-readable data such as a string. The alias identifier is a unique identifier. In some embodiments, the alias identifier may be globally unique (e.g., unique among all address owners) or may be unique per user account. The physical address may be embodied as a postal address, mailing address, street address, or other indication of a physical location. In block 308, the alias server 102 scrubs the physical address to determine a corrected address. Scrubbing the address may include converting the input address to a canonical form or otherwise generating a recognizable address. For example, the alias server 102 may ensure that the address includes a correct street type (e.g., “street,” “drive,” etc.). As another example, the alias server 102 may expand a provided five-digit ZIP code into nine-digit ZIP+4 format.

In block 310, the alias server 102 associates the corrected physical address with the supplied alias identifier. The alias server 102 may store the physical address in association with the alias identifier in the address database 210. Each physical address may be associated with one or more alias identifiers associated with a particular address owner. The contents of the address database 210 may be encrypted or otherwise stored securely. In some embodiments, in block 312 the alias server 102 may update the physical address for an existing alias identifier. For example, the address owner may update the physical address after moving, after opening a new business location, or for other reasons. After storing the physical address, the method 300 proceeds to block 314.

In block 314, the alias server 102 determines whether to consume an alias identifier. For example, the alias server 102 may determine whether a request has been received from an address consumer device 106. If not, the method 300 loops back to block 302 to continue managing alias identifiers. If the alias server 102 determines to consume an alias identifier, the method 300 advances to block 316.

In block 316, the alias server 102 receives an alias API request from the consumer device 106. The API request identifies an alias identifier, and in some embodiments may identify a requested operation or requested access role for the API request. As described further below, the alias identifier may be received by the consumer device 106 from an address owner, for example in connection with a request for services.

In block 318, the alias server 102 authenticates the address consumer device 106. The alias server 102 may use any appropriate technique to authenticate the address consumer device 106, such as verifying one or more pre-provisioned credentials provided by the address consumer device 106. If the consumer device 106 is not successfully authenticated, the alias server 102 may indicate an error or otherwise stop execution of the method 300. In some embodiments, in block 320 the alias server 102 may identify an API access role associated with the consumer device 106. For example, the alias server 102 may identify one or more credentials provided by the consumer device 106 as being associated with a particular API access role. API access roles may include a shipping partner role, a partner role, a validity confirmation role, or an administrator role.

In block 322, the alias server 102 retrieves a physical address associated with the supplied alias identifier. As described above, the physical address is supplied by the address owner and stored securely by the alias server 102 in the address database 210. The alias server 102 may decrypt or otherwise securely access the contents of the address database 210.

In block 324, the alias server 102 generates a response based on the API access role of the consumer device 106. The response may include data that is extracted from or otherwise based on the physical address associated with the alias identifier. Each API access role may be associated with a particular level of access to the physical address. In some embodiments, in block 326 the alias server 102 may include the entire physical address for a shipping partner role. Shipping partners may include post offices, couriers, or other entities that require access to the physical address to perform requested services. In some embodiments, in block 328 the alias server 102 may include a postal code (e.g., ZIP code) or other low-resolution address for a partner role. Partners may include online retailers or other entities that do not require access to an exact address to perform requested services. For example, the low-resolution address may be used to provide shipping estimates. In some embodiments, in block 330 the alias server 102 may determine validity of the supplied alias identifier for a confirmation role. In those embodiments, the response may include an indication of whether the supplied alias identifier is valid and/or currently associated with a valid address.

In block 332, the alias server 102 sends the generated response to the consumer device 106. As described below, the consumer device 106 may use the response (e.g., the address or other data) to perform services requested by the address owner. After sending the response, the method 300 loops back to block 302 to continue managing alias identifiers. Additionally, although illustrated in FIG. 3 as being executed sequentially, it should be understood that in some embodiments, one or more operations of the method 300 may be performed in parallel or otherwise executed concurrently.

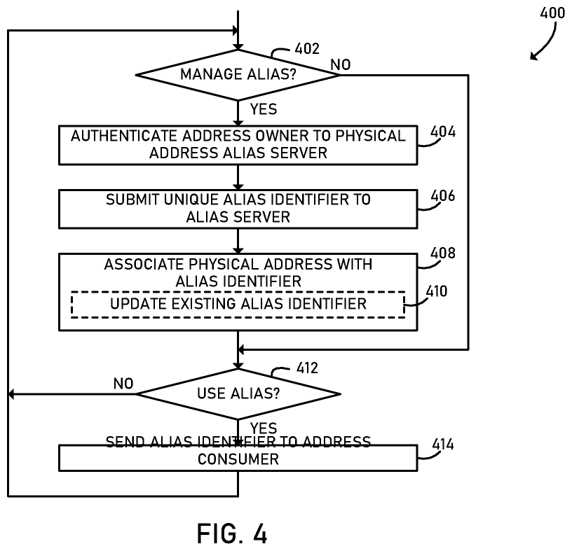

Referring now to FIG. 4, in use, the owner device 104 may execute a method 400 for physical address aliasing. It should be appreciated that, in some embodiments, the operations of the method 400 may be performed by one or more components of the environment 220 of the owner device 104 as shown in FIG. 2. The method 400 begins with block 402, in which the owner device 104 determines whether to manage an alias identifier. The owner device 104 may, for example, determine whether a user of the owner device 104 has requested to manage an alias identifier using a web browser or other interactive application or otherwise activated alias management. If the owner device 104 determines not to manage an alias identifier, the method 400 branches ahead to block 412, described below. If the owner device 104 determines to manage an alias identifier, the method 400 advances to block 404.

In block 404, the address owner device 104 authenticates to the alias server 102. The owner device 104 may use any appropriate technique to authenticate to the alias server 102. For example, the owner device 104 may securely transmit credentials provided by a user to the alias server 102. As described above, if the owner device 104 is not successfully authenticated, the alias server 102 may indicate an error or otherwise stop execution of the method 400. If the owner device 104 is successfully authenticated, the method 400 advances to block 406.

In block 406, the owner device 104 submits an alias identifier to the alias server 102. As described above, the alias identifier may be embodied as human-readable data such as a string. The alias identifier is a unique identifier. In some embodiments, the alias identifier may be globally unique (e.g., unique among all address owners) or may be unique per user account. The alias identifier may be submitted using a web browser or other interactive application.

Similarly, in block 408 the owner device 104 associates a physical address with the alias identifier. The owner device 104 may, for example, submit the physical address using a web browser or other interactive application. As described above, the physical address may be embodied as a postal address, mailing address, street address, or other indication of a physical location. In some embodiments, in block 410 the owner device 104 may update a physical address associated with an existing alias identifier. After updating the alias identifier and the physical address, the method 400 advances to block 412.

In block 412, the owner device 104 determines whether to use the alias identifier. For example, the owner device 104 may, for example, determine whether a user of the owner device 104 has requested to provide the alias identifier to another device. If not, the method 400 loops back to block 402 to continue managing alias identifiers. If the owner device 104 determines to use the alias identifier, the method 400 advances to block 414, in which the owner device 104 may send the alias identifier to an address consumer device 106. For example, the alias identifier may be sent by a user using a web browser or other interactive application of the owner device 104. After using the alias identifier, the method 400 loops back to block 402 to continue managing alias identifiers.

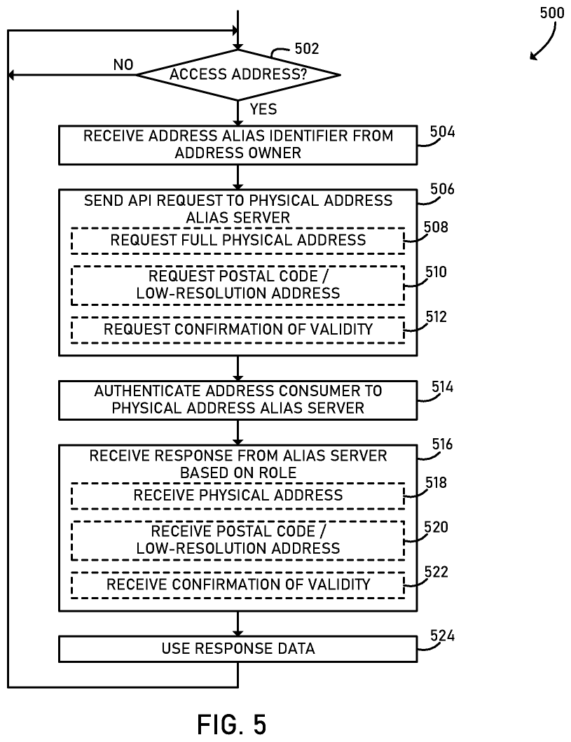

Referring now to FIG. 5, in use, the consumer device 106 may execute a method 500 for physical address aliasing. It should be appreciated that, in some embodiments, the operations of the method 500 may be performed by one or more components of the environment 240 of the consumer device 106 as shown in FIG. 2. The method 500 begins with block 502, in which the consumer device 106 determines whether to access a physical address. For example, the consumer device 106 may access the address in response to a request from an address owner for services. If the consumer device 106 determines not to access an address, the method 500 loops back to block 502 to continue monitoring for address accesses. If the consumer device 106 determines to access an address, the method 500 advances to block 504.

In block 504, the consumer device 106 receives an address alias identifier from an address owner. In some embodiments, the consumer device 106 may receive the address identifier directly from an owner device 104. For example, the owner device 104 may submit the alias identifier with an online order or other request. In some embodiments, the consumer device 106 may receive the address identifier from an intermediary device, which may be an owner device 104 and/or a consumer device 106. For example, an owner device 104 may provide the alias identifier to a consumer device 106 in a partner role, such as an online retailer. The partner role consumer device 106 may, in turn, provide the alias identifier to a consumer device 106 in a shipper role, such as a post office or courier. Additionally or alternatively, in some embodiments, the consumer device 106 may receive the alias identifier from a different source. For example, an entity in a shipper role such as a post office or courier may receive a physical package marked with the alias identifier, and the alias identifier may be provided to the consumer device 106 manually or automatically (e.g., using optical character recognition).

In block 506, the consumer device 106 sends an alias API request to the alias server 102. As described above, the API request identifies an alias identifier, and in some embodiments may identify a requested operation or requested access role for the API request. In some embodiments, in block 508 the consumer device 106 may request a full physical address for the alias identifier. For example, a consumer device 106 in a shipper role or administrator role may request the full physical address. In some embodiments, in block 510 the consumer device 106 may request a postal code (e.g., ZIP code) or other low-resolution address for the alias identifier. For example, a consumer device 106 in a partner role may request the low-resolution address. In some embodiments in block 512 the consumer device 106 may request confirmation of validity for the alias identifier. For example, a consumer device 106 in a confirmation role may request confirmation of validity.

In block 514, the consumer device 106 authenticates to the alias server 102. As described above, the alias server 102 may use any appropriate technique to authenticate the address consumer device 106, such as verifying one or more pre-provisioned credentials provided by the address consumer device 106 to the alias server 102. If the consumer device 106 is not successfully authenticated, the alias server 102 may indicate an error or otherwise stop execution of the method 500. As described above, in some embodiments the alias server 102 may identify an API access role associated with the consumer device 106, such as a shipping partner role, a partner role, a validity confirmation role, or an administrator role.

In block 516, the consumer device 106 receives a response from the alias server 102. The response includes data based on the physical address associated with the alias identifier and the access role associated with the consumer device 106. In some embodiments, in block 518 the consumer device 106 may receive a full physical address. In some embodiments, in block 520 the consumer device 106 may receive a postal code or other low-resolution address. In some embodiments, in block 522 the consumer device 106 may receive a confirmation of validity.

In block 524, the consumer device 106 may use the response data. The consumer device 106 may use the response data to perform a service requested by the owner device 104 or other source of the alias identifier. The response data may be used with any other techniques or processes appropriate for the provided address data. For example, the consumer device 106 may ship, mail, transport, create a shipping label, or otherwise route a package or other item to the physical address identifier in the response. As another example, the consumer device 106 may use a postal code included in the response to generate a shipping estimate or otherwise consume the postal code. After using the response data, the method 500 loops back to block 502 to continue access addresses.

1. A computing device for physical address aliasing, the computing device comprising:
an application programing interface to receive a request from an address consumer device, wherein the request comprises an alias identifier; and
a data access layer to: (i) authenticate the address consumer device, and (ii) retrieve a physical address associated with the alias identifier from an address database in response to authentication of the address consumer device;
wherein the application programming interface is further to send a response based on the physical address to the address consumer device in response to receipt of the request and retrieval of the physical address.

2. The computing device of claim 1, wherein the alias identifier comprises a human-readable unique identifier.

3. The computing device of claim 1, wherein the data access layer is further to:
identify an access role associated with the address consumer device in response to the authentication of the address consumer device; and
generate the response based on the physical address and the access role.

4. The computing device of claim 3, wherein:
the access role comprises a shipper role and the response comprises the physical address;
the access role comprises a partner role and the response comprises a low-resolution address based on the physical address; or
the access role comprises a confirmation role and the response comprises an indication of whether the address alias is valid.

5. The computing device of claim 4, wherein the low-resolution address comprises a postal code.

6. The computing device of claim 1, further comprising an owner access layer to:
authenticate an address owner device; and
receive the physical address and the alias identifier from the address owner device;
wherein the data access layer is further to associate the physical address and the alias identifier in the address database in response to authentication of the address owner device.

7. The computing device of claim 6, wherein to associate the physical address and the alias identifier comprises to update the physical address associated with the alias identifier.

8. The computing device of claim 6, wherein:
the owner access layer is further to scrub the physical address to generate a corrected address; and
to associate the physical address and the alias identifier comprises to associate the corrected physical address and the alias identifier.

9. One or more computer-readable storage media comprising a plurality of instructions that in response to being executed cause a computing device to:
receive a request from an address consumer device, wherein the request comprises an alias identifier;
authenticate the address consumer device;
retrieve a physical address associated with the alias identifier from an address database in response to authenticating the address consumer device; and
send a response based on the physical address to the address consumer device in response to receiving the request and retrieving the physical address.

10. The one or more computer-readable storage media of claim 9, wherein the alias identifier comprises a human-readable unique identifier.

11. The one or more computer-readable storage media of claim 9, further comprising a plurality of instructions that in response to being executed cause the computing device to:
identify an access role associated with the address consumer device in response to authenticating the address consumer device; and
generate the response based on the physical address and the access role.

12. The one or more computer-readable storage media of claim 9, further comprising a plurality of instructions that in response to being executed cause the computing device to:
authenticate an address owner device;
receive the physical address and the alias identifier from the address owner device; and
associate the physical address and the alias identifier in the address database in response to authenticating the address owner device.

13. The one or more computer-readable storage media of claim 12, wherein to associate the physical address and the alias identifier comprises to update the physical address associated with the alias identifier.

14. One or more computer-readable storage media comprising a plurality of instructions that in response to being executed cause a computing device to:
send a request to an address alias server, wherein the request comprises an alias identifier;
authenticate to the address alias server; and
receive a response from the address alias server in response to sending the request and authenticating to the address alias server, wherein the response is indicative of a physical address associated with the alias identifier.

15. The one or more computer-readable storage media of claim 14, further comprising a plurality of instructions that in response to being executed cause the computing device to:
receive the alias identifier from an address owner device;
wherein to send the request comprises to send the request in response to receiving the alias identifier.

16. The one or more computer-readable storage media of claim 14, further comprising a plurality of instructions that in response to being executed cause the computing device to consume the response indicative of the physical address.

17. The one or more computer-readable storage media of claim 14, wherein the request identifies a requested access role.

18. The one or more computer-readable storage media of claim 14, wherein to authenticate to the address alias server comprises to authenticate a requested access role.

19. The one or more computer-readable storage media of claim 18, wherein the requested access role comprises a shipper role, a partner role, or a confirmation role.

20. The one or more computer-readable storage media of claim 14, wherein:
to receive the response indicative of the physical address comprises to receive the physical address;
to receive the response indicative of the physical address comprises to receive a low-resolution address based on the physical address; or
to receive the response indicative of the physical address comprises to receive an indication of whether the address alias is valid.

21.-25. (canceled)
